(19) United States
(12) Patent Application Publication
(10) Pub. No.: US 2006/0193959 A1
(43) Pub. Date: Aug. 31, 2006

(54) Low calorie injection molded starch-based pet chew bodies

(76) Inventors: Li Nie, Parkville, MO (US); Michael D. Parker, Lawrence, KS (US); Kyungsoo Woo, Shawnee, KS (US); Clodualdo C. Maningat, Platte City, MO (US); Sukh D. Bassi, Atchison, KS (US)

Correspondence Address: LATHROP & GAGE LC, 4845 PEARL EAST CIRCLE, SUITE 300, BOULDER, CO, 80301, US

(21) Appl. No.: 11/360,651

(22) Filed: Feb. 23, 2006

Related U.S. Application Data
(63) Continuation-in-part of application No. 10/755,597, filed on Jan. 12, 2004.
Application No. 10/755,597 is a continuation-in-part of application No. 10/284,553, filed on Oct. 30, 2002.

(51) Int. Cl. A21D 10/00

(52) U.S. Cl. 426/549

(57) ABSTRACT

Injection molded starch-based chew products are provided which are tough, non-brittle, non-slimy, quick to hydrate, low calorie and high in total dietary fiber. The starch-based chew products are formulated from a combination of resistant starch and pregelatinized starch or pre-cooked flour along with plasticizer, water, lubricants and other optional ingredients.

### BACKGROUND

1. Field of the Invention

The present invention relates to injection molded starch-based edible products. More particularly, the injection molded products and injection methods useful in forming the products may provide low calorie pet chews.

2. Description of the Related Art

Starch serves as a food reserve in plants, and is an important component in an animal diet, where the digestion of starch is mediated by salivary and pancreatic α-amylase. The α-amylase enzyme catalyzes formation of maltose, maltotriose and dextrin, which are further hydrolyzed to d-glucose in the brush-border of the small intestine. However, some starch resists digestion by α-amylase. Englyst et al. (1992, Eur. J. Clin Nutr) classified ingested starch based on its probable digestive fate in vivo. They proposed three classes of dietary starch: 1) rapidly digestible starch (RDS), which is likely to be digested in the intestine; 2) slowly digestible starch (SDS), which is likely to be slowly yet completely digested in the small intestine; and 3) resistant starch (RS), which is unlikely to be digested in the small intestine.

RS has been subdivided into four categories depending on the cause of resistance (Englyst et al. 1992, Eerlingen et al. 1993): RS1, physically inaccessible starch due to entrapment in a nondigestible matrix; RS2, raw starch granules with crystallinity; RS3, retrograded amylose; and RS4, chemically modified starch.

Together with SDS, RS has been linked to foods with reduced glycemic indexes which do not provoke an intense insulin response and are thought to be beneficial for all animals, especially those with diabetes.

RS is also recognized as one component of dietary fiber, where it contributes zero calories and has been shown to be a mild laxative. RS is partially fermented in the colon to short chain fatty acids; the short chain fatty acids reduce fecal pH and consequently inhibit the activity of 7-dehydroxylase, which forms secondary bile acids associated with an increased risk of colon cancer. Short chain fatty acids, such as acetic, propionic and butyric, are also shown to stimulate colonic blood flow and electrolyte absorption.

Starch-Based Products

A number of starch-based injection molded animal chew products exist. Traditional products are formed of gelatinized starch or flour that is readily digestible (RDS) and high in caloric content. Consumption of such products by domestic animals, along with increasingly sedate lifestyles, has led to an increase in the development of animal diseases including diabetes and other obesity-related conditions.

The physical characteristics of starch-based injection molded products are also problematic. For example, the products tend to become slimy and may present a staining problem when consumed in the vicinity of carpet and upholstery. Further, the chew products are generally brittle and messy due to small pieces that break off during chewing. Such breakage can create sharp edges that may lacerate an animal's oral cavity and digestive tract, while larger pieces can lead to gastrointestinal blockages.

Copending U.S. patent application Ser. No. 10/284,553 discloses non-brittle long lasting chew products made by profile extrusion. Pregelatinized starches that are capable of retrograding under proper formulation and processing conditions are used to create toughness in the chew products. The chew products typically last between 10-25 minutes, which is perceived as an ideal chew time for dogs.

Copending U.S. patent application Ser. No. 10/755,597 discloses long lasting chews formulated from a mixture of pregelatinized and native starch. The formulation allows the extrudate to be reshaped or embossed, while also improving melt temperature control. The formulation of the '597 application, however, cannot be readily used for making injection molded products. Pellets of the '597 formulation tend to stick together, which is problematic for traditional injection molding systems, while products formed by a one-step process, which eliminates the need to use a pelletized feed, are too soft for proper ejection and maintenance of product shape. The final products also suffer from rapid retrogradation and brittleness because high barrel temperatures in the injection molding machine and high shear forces, created as the melt moves through the cavity gate at typical fill speeds, rupture the partially gelatinized starch which is created from the native starch during the extrusion process.

Currently, it is not possible to form non-brittle, starch-based products by injection molding.

### SUMMARY

A low calorie, high fiber, injection molded comestible body includes between 20-75% by weight of a binder, the binder comprising one or more of pregelatinized starch and pre-cooked flour; between 15-70% by weight of a resistant starch; between 10-24% by weight of a plasticizer; between 6-16% by weight water; and less than 3.0% by weight of a lubricant.

A method of making a comestible body, the method comprising the steps of (a) mixing ingredients that include between 20-75% by weight of a binder, the binder comprising one or more of pregelatinized starch and pre-cooked flour; between 15-70% by weight of a resistant starch; between 10-24% by weight of a plasticizer; between 6-16% by weight water; and less than 3.0% by weight of a lubricant, in an extruder to form a melt and (b) pushing the melt into a mold cavity to form a molded article.

### DETAILED DESCRIPTION

The materials and processing described below address the problems outlined above and advance the art by providing an injection molded, low calorie chew product that is non-brittle. A chew body produced in accordance with the instrumentalities disclosed herein includes a quantity of resistant starch, in addition to a quantity of pregelatinized starch or pre-cooked flour. High amylose starches, chemically modified type 4 resistant starches or a combination of the two can be successfully formulated with pregelatinized starch or pre-cooked flour binders to create chews with low caloric content and high total dietary fiber (TDF). The resulting products are tough for an animal to chew, non-brittle, non-slimy and readily hydratable for quick disintegration, as well as characterized by a total dietary fiber content of at least 5%.

Pregelatinized starch and/or pre-cooked flour is used as a binder to form a matrix. Any pregelatinized starch can be used in the present formulations, including pregelatinized starches selected from pregelatinized potato starch, corn starch, wheat starch, rice starch, tapioca starch or mixtures thereof. Pregelatinized rice flour may also be substituted as a weight equivalent for pregelatinized rice starch because rice flour has a very low protein content and is predominantly comprised of starch. Pre-cooked flour, where the starch is gelatinized by cooking the flour, can be pre-cooked potato flour, corn flour, wheat flour, rice flour, tapioca flour or mixtures thereof. The amount of pregelatinized starch and/or pre-cooked flour binder in a chew body can vary from 20-75%. Pregelatinized potato starch has been found to provide the greatest toughness for a chew body, whereas pre-cooked flour provides less toughness than pregelatinized starch extracted from the flour. A portion of the binder may be replaced by pregelatinized acid thinned starch, dextrose, maltodextrins and/or maltrins. Dextrose, maltodextrin and maltrin reduce melt viscosity and die pressure, as well as product toughness and sliminess. The amount of dextrose, maltodextrin and/or maltrin in a chew body may vary from 0-40% by weight of the final product, and typically equals less than the amount of binder in a chew body.

The chew bodies receive favorable chew properties by selection of pregelatinized starches that exhibit retrograding properties under the process conditions, formulation and subsequent storage conditions. Retrograde effects are produced, for example, by heating a mixture that contains a pregelatinized starch followed by slow cooling of the heated mixture or an extended storage period that produces retrograding effects. The pregelatinized starch molecules crystallize or physically crosslink upon cooling and storage, provided a small but sufficient quantity of plasticizer and water are present.

Resistant starches for use in the present formulations include high amylose starch and/or chemically modified starch. The resistant starches maintain their granular structure throughout the formulation and injection molding processes. Decreased susceptibility of the resistant starch to enzymatic digestion reduces the caloric content of the final product and increases total dietary fiber.

High amylose starches for use in the present formulations must have more than 40% amylose content. The high amylose starch can also be heat treated and/or enzyme treated for enhanced crystallinity and resistance to enzymatic digestion. Examples of commercially available high amylose resistant starches include: Hylon IV, Hylon V, Hylon VII, Hi-maize 240, Hi-maize 260, Hi-maize 1043 and Amylogel™ 03003. Chemically modified resistant starches are preferably prepared by cross-linking. Highly cross-linked, resistant starches are classified as RS₄-type starches and may be manufactured by processes disclosed, for example, in U.S. Pat. Nos. 5,855,946 and 6,299,907. Examples of commercially available chemically modified resistant starch products include: Fibersym® 70, Fibersym® 80-ST, FiberRite®-RW and Actistar®RT75330. The amount of resistant starch in a chew body can vary from 15-70%. If the resistant starch is less than 15%, part ejection from the mold may be difficult and the product may be too soft to maintain shape. If resistant starch content is above 70%, the chew body may not achieve the desired toughness.

Preferred pet chew bodies also contain from about 10-24% by weight plasticizer, more preferably between about 11-23% by weight, and most preferably between about 12-22% by weight. The plasticizer is preferably glycerine, propylene glycol, or mixtures thereof, with glycerine being most preferred. The plasticizer helps control the water activity of the product to prevent microbial activity. Preferably, the final product has a water activity of less than 0.7 at room temperature.

In the past, humectants such as sorbitol, mannitol, sugars, corn syrups and reducing sugars have been utilized in pet chew formulations for helping the products maintain moisture. The use of such humectants is presently undesirable, though their use is not necessarily proscribed.

Preferred pet chew bodies may contain water, for example, between 6-16% by weight water, more preferably between 7-14% by weight, and most preferably between 8-13% by weight. If the water content is higher than 16%, the chew may not exhibit the desired toughness. If the water content is below 6%, the product may be slimy. Water is a functional element of the final product. It contributes to retrograde activity that may enhance the chew body strength even while the chew body is in storage. The water need not be active water to achieve this benefit.

Preferred pet chew bodies may contain less than 3% by weight of lubricants. Such lubricants improve melt flow and help prevent the products from sticking to the mold surface during processing. The lubricants may include, for example, glycerol monostearate, glycerol distearate, glycerol monolaurate, hydrolyzed lecithin and derivatives, hydrolyzed vegetable oils, vegetable oils, animal fats, magnesium stearate, calcium stearate, sodium stearate, potassium stearate and mixtures thereof. Preferred lubricants are glycerol monostearate and magnesium stearate.

Preferred pet chew bodies may also contain optional ingredients such as palatibility enhancers, fibers, dental cleaning agents, breath freshening agents, flavoring agents, antioxidants, essential minerals, nutrients, herbs and colorants. Palatability enhancers are used in numerous pet food products to attract the animal to the food item. The palatability enhancer is preferably selected from the group consisting of meat and poultry broth concentrate or spray-dried powder, liver and liver digest broth concentrate or powder, hydrolyzed proteins, autolyzed yeast, yeast extract, distillery dry feed and vegetable-based natural flavors. One particularly preferred palatability enhancer is from a liver source. Fibers may include cellulose fiber, beet pulp, brans and innulin. Dental cleaning agents may include fillers, phosphates and/or acids. Breath-freshening agents may include chlorophyll, mint, parsley and/or kelp. Flavoring agents may include garlic flavor, meat flavors, cheese flavors, fruit flavors and smoke flavors. Antioxidants can be both natural and synthetic. Colorants may include both natural colorants and synthetic dyes or pigments. One preferred colorant is titanium dioxide. It is preferable that such additional ingredients individually comprise less than 5% by weight of the final product.

Preferred pet chews may also contain protein to improve the nutritional profile of the chews and help reduce melt viscosity. Suitable proteins include meat proteins, milk proteins, vegetable proteins, egg proteins and protein hydrolyzates of various sources. Adding protein to the formulation generally reduces the toughness of the chew by disrupting the starch binder matrix. The amount of protein in the formulation is preferably from 0-30% by weight of the final product.

Methods of forming injection molded, self-sustaining comestible bodies include providing a mixture of ingredients as described above and injection molding the mixture. Preferred methods also include the step of pre-conditioning the mixture prior to injection molding thereof and the step of cooling the injection molded body to room temperature after molding thereof.

Low calorie, starch-based pet chews with highly desirable chew character are created by mixing powdered ingredients with water and glycerine in a twin or single screw extruder to form pellets. The resulting pellets are fed to an injection molding machine at higher than extrusion melt temperature to form the chews in a mold kept at low temperature. The chews can also be formed in a one-step injection molding machine where the powdered ingredients and liquid are mixed and fed directly into the mold cavities, thus eliminating the pelleting step.

In a two step process, the powdered ingredients are mixed with liquid in an extruder to form the melt. At the die end of the extruder, the pellets are formed with a cutting knife. The pellets are air transferred to a cooling bed. After cooling, the pellets are packed into bags. The extruder used for making the pellets can be a single screw extruder or a twin screw extruder. Twin screw extruders are preferred for better mixing. The powder and liquid can be pre-conditioned in a conditioning chamber before being fed to the extruder feed port. The liquid can also be introduced directly into the extruder through a barrel port. An example of a suitable commercial extruder is the TX-85 twin screw extruder from Wenger. The barrel temperature of the extruder is controlled between 50-100° C.

Pellets prepared by extrusion compounding can be fed into an injection molding machine to make chews of various shapes. The barrel temperature of the molding press is controlled from about 100-140° C. If the temperature is too low, molding is difficult due to high melt viscosity. The temperature of the mold is maintained at room temperature. The molded product is placed on a conveying belt for partial cooling. The molded product may be transferred to a cooler for cooling to room temperature. After exiting the cooler, the products can be packaged in canisters, zip-lock bags or pouches, hot melt sealed bags, etc.

Proper packaging improves the quality of products delivered to the ultimate consumer. Because the preferred plasticizers for use in the disclosed formulations have limited abilities to hold in moisture, especially in low relative humidity environments, the packaging material preferably provides a sufficient barrier to prevent the product from losing too much moisture too quickly during storage. Excessively rapid moisture loss may cause the product to become brittle, especially in environments having a relative humidity of less than 35%. If moisture is allowed to escape slowly, over a prolonged period of time, the pregelatinized starch molecules undergo physical crosslinking, or retrogradation. This crosslinking provides added toughness to the final product thereby giving the chew a longer chew time and non-slimy feel. Exemplary packaging material demonstrating good moisture barrier properties may be used as packaging materials with such examples as aluminum-plastic film laminates, PET, PVC, PS, PP thermoforms, PVP based-laminates, PE, PP films, and the like.

The following examples set forth particular low calorie, injection molded starch-based chew products in accordance with the instrumentalities reported herein, as well as methods of preparing such products. It is to be understood that these examples are provided by way of illustration only, and nothing therein should be taken as a limitation on the scope of what has been invented, which is defined by the claims that follow.

### EXAMPLE 1

Representative pet chews were formulated from the ingredients shown in Table 1 (below).

Powdered ingredients were mixed with glycerine solution in a pre-conditioner (TX-85 Wenger extruder). The mixture was fed to the extruder and water was injected directly into the extruder through a barrel pumping port. The barrel temperature of the extruder was set at 160° F., the melt temperature at the die end was controlled at about 190° F. Upon exiting the extruder, the melt passed through a die plate and was cut into pellets. The hot and soft pellets were transferred pneumatically into a belt cooler. After cooling, the pellets were packed automatically into 35 lb bags. It was determined that the pellets lost about 2% moisture depending on the relative humidity of the production environment.

The pellets were fed into an injection molding press. The barrel temperature was set at 240° F. The mold was kept at about room temperature using a water-jacketed mold. Injection pressure to fill the mold was typically less than 18,000 psi, and molding cycle time was typically less than 30 seconds.

Parts ejected from the molding machine were put into sealed containers or immediately packed to prevent moisture loss. After storing for more than three weeks, the products were non-brittle (even without packaging), had good toughness, were non-slimy and hydrated quickly. Disintegration occurred within six hours when the product was soaked in 100° F. water, which was used to approximate body temperature and digestive conditions. Total dietary fiber using AOAC 991.43 method was determined to be 13.1%.

TABLE 1

| | | |
|---|---|---|
| Penplus UM (pregelatinized potato starch) | 34 | parts |
| Maltrin 150 | 15 | parts |
| Hylon VII (high amylose resistant starch) | 45 | parts |
| H-base (palatant) | 3.0 | parts |
| Glycerol monostearate | 1.2 | part |
| Magnesium stearate | 0.8 | parts |
| Vegetable oil | 1.0 | parts |
| Covi-ox T-90 (antioxidant mix) | 0.05 | parts |
| Chlorophyll KK (colorant) | 0.03 | parts |
| Glycerine | 18 | parts |
| Water | 8.0 | parts |
| TOTAL | 126.08 | parts |

### EXAMPLE 2

Representative pet chews were formulated from the ingredients shown in Table 2 (below). The chews were made according to procedures set forth in Example 1. The products were less tough than those of Example 1.

TABLE 2

| | | |
|---|---|---|
| Midsol Pregel-10 (pregelatinized wheat starch) | 34.15 | parts |
| Vital wheat gluten (wheat protein) | 3 | parts |
| HWG 2009 (hydrolyzed wheat gluten) | 12 | parts |
| Hylon VII (high amylose resistant starch) | 45 | parts |
| H-base (palatant) | 3.0 | parts |
| Glycerol monostearate | 2.0 | part |
| Magnesium stearate | 0.8 | parts |
| Covi-ox T-90 (antioxidant mix) | 0.05 | parts |
| Glycerine | 18 | parts |
| Water | 8.0 | parts |
| TOTAL | 126.0 | parts |

### EXAMPLE 3

Representative pet chews were formulated from the ingredients shown in Table 3 (below). The chews were made according to procedures set forth in Example 1. The products exhibited a whitish surface appearance, were less tough than the chews of Examples 1 and 2, and had a total dietary fiber content of 31.8%.

TABLE 3

| | | |
|---|---|---|
| PFG 1000 (pre-cooked corn flour) | 52.15 | parts |
| Fibersym ® 70 (chemically modified resistant starch) | 40 | parts |
| H-base (palatant) | 3.0 | parts |
| Glycerol monostearate | 2.0 | part |
| Vegetable oil | 2.0 | parts |
| Magnesium stearate | 0.8 | parts |
| Covi-ox T-90 (antioxidant mix) | 0.05 | parts |
| Glycerine | 18 | parts |
| Water | 8.0 | parts |
| TOTAL | 126.0 | parts |

Changes may be made in the above compositions and methods without departing from the invention described in the Summary and defined by the following claims. It should thus be noted that the matter contained in the above description or shown in the accompanying drawings should be interpreted as illustrative and not limiting.

All references cited are incorporated by reference herein.

We claim:

1. A low calorie, high fiber, injection molded comestible body comprising:
between 20-75% by weight of a binder, the binder comprising one or more of pregelatinized starch and pre-cooked flour;
between 15-70% by weight of a resistant starch;
between 10-24% by weight of a plasticizer;
between 6-16% by weight water; and
less than 3.0% by weight of a lubricant.

2. The body of claim 1, characterized by a property of staying non-brittle at 35% relative humidity and above with no packaging.

3. The body of claim 1, characterized by a property of disintegrating within six hours when immersed in 100° F. water.

4. The body of claim 1, wherein said resistant starch is selected from a high amylose resistant starch and a chemically modified starch.

5. The body of claim 4 wherein said high amylose resistant starch comprises at least 40% amylose.

6. The body of claim 4 wherein said chemically modified starch exhibits a total dietary fiber content of at least 30% using AOAC 991.41 test method.

7. The body of claim 1, wherein said resistant starch is selected from the group consisting of Hylon IV, Hylon V, Hylon VII, Hi-maize 240, Hi-maize 260, Hi-maize 1043, Amylogel™ 03003, Fibersym® 70, Fibersym ® 80-ST, FiberRite®-RW, Actistar™RT 75330 and mixtures thereof.

8. The body of claim 1, wherein said pregelatinized starch is selected from the group consisting of potato starch, wheat starch, corn starch, rice starch, rice flour, tapioca starch and mixtures thereof.

9. The body of claim 1, wherein said pre-cooked flour is selected from the group consisting of potato flour, wheat flour, corn flour, rice flour, tapioca flour and mixtures thereof.

10. The body of claim 1, wherein said plasticizer is selected from the group consisting of glycerin, propylene glycol and mixtures thereof.

11. The body of claim 1, wherein said plasticizer comprises glycerine.

12. The body of claim 1, wherein said lubricant is selected from the group consisting of glycerol mono and di-stearates, glycerol monolaurate, hydrolyzed lecithin and derivatives, hydrolyzed vegetable oils, vegetable oils, animal fats, magnesium stearate, calcium stearate, sodium stearate, potassium stearate and mixtures thereof.

13. The body of claim 1, wherein said lubricant comprises glycerol monostearate.

14. The body of claim 1, wherein said lubricant comprises magnesium stearate.

15. The body of claim 1 further comprising up to 5% palatability enhancer.

16. The body of claim 15, wherein said palatability enhancer is selected from the group consisting of liver, liver digest broth concentrate, liver broth powder, meat broth concentrate, meat broth powder, poultry broth concentrate, poultry broth powder, hydrolyzed proteins, autolyzed yeast, yeast extract, distillery dry feed, vegetable-based natural flavors and mixtures thereof.

17. The body of claim 1 further comprising one or more additional ingredients selected from the group consisting of coloring agents, fibers, antioxidants, essential minerals, nutrients, herbs, flavoring agents, dental cleaning agents and breath fresheners.

18. The body of claim 17, wherein said fiber is selected from the group consisting of cellulose fiber, beet pulp, bran, innulin and mixtures thereof.

19. The body of claim 17, wherein said dental cleaning agent is selected from the group consisting of fillers, phosphates, acids and mixtures thereof.

20. The body of claim 17, wherein said breath freshening agent is selected from the group consisting of chlorophyll, mint, parsley, kelp and mixtures thereof.

21. The body of claim 17, wherein said flavoring agent is selected from the group consisting of garlic flavor, meat flavor, cheese flavor, fruit flavor, smoke flavor and mixtures thereof.

22. The body of claim 17, wherein said colorant comprises titanium dioxide.

23. The body of claim 17, wherein said additional ingredient comprises less than 5% by weight of said body.

24. The body of claim 1 further comprising a protein, the protein selected from the group consisting of meat proteins, milk proteins, vegetable proteins, egg proteins, protein hydrolyzates and mixtures thereof.

25. The body of claim 24, wherein said protein comprises less than 30% by weight of said body.

26. The body of claim 1, wherein a portion of said binder is replaced with a substitute selected from the group consisting of pregelatinized acid thinned starch, dextrose, maltodextrin, maltrins and mixtures thereof.

27. The body of claim 26, wherein said substitute comprises less than 40% by weight of said body.

28. A method of making a comestible body, the method comprising the steps of:
(a) mixing ingredients that include between 20-75% by weight of a binder, the binder comprising one or more of pregelatinized starch and pre-cooked flour; between 15-70% by weight of a resistant starch; between 10-24% by weight of a plasticizer; between 6-16% by weight water; and less than 3.0% by weight of a lubricant, in an extruder to form a melt; and
(b) pushing the melt into a mold cavity to form a molded article.

29. The method of claim 28, wherein extrusion temperature is controlled such that the melt temperature does not exceed 100° C. at die end.

30. The method of claim 28, wherein molding barrel temperature is kept below 140° C. and mold temperature is kept at room temperature.
